(19) United States
(12) Patent Application Publication
(10) Pub. No.: US 2014/0012816 A1
(43) Pub. Date: Jan. 9, 2014

(54) EVALUATION APPARATUS, DISTRIBUTED STORAGE SYSTEM, EVALUATION METHOD, AND COMPUTER READABLE RECORDING MEDIUM HAVING STORED THEREIN EVALUATION PROGRAM

(71) Applicant: FUJITSU LIMITED, Kawasaki-shi (JP)

(72) Inventors: Jun KATO, Kawasaki (JP); Toshihiro OZAWA, Yokohama (JP); Munenori MAEDA, Yokohama (JP); Masahisa TAMURA, Kawasaki (JP); Tatsuo KUMANO, Kawasaki (JP); Ken IIZAWA, Yokohama (JP)

(73) Assignee: FUJITSU LIMITED, Kawasaki-shi (JP)

(21) Appl. No.: 13/902,845

(22) Filed: May 26, 2013

(30) Foreign Application Priority Data
Jul. 9, 2012 (JP) 2012-153589

(51) Int. Cl. G06F 17/30

(52) U.S. Cl. CPC G06F 17/30371
USPC 707/688

(57) ABSTRACT

An evaluation apparatus includes: a calculation unit configured to calculate the evaluation value of the evaluation target content by using an evaluation value estimation algorithm, based on a count value for the evaluation target content and a sum value of respective count values for the plurality of contents; a verification unit configured to verify whether the sum value of the respective count values for the plurality of contents reaches a predetermined value; and a processing unit configured to reduce the respective count values of the plurality of contents, when the sum value of the respective count values for the plurality of contents reaches the predetermined value, and is capable of detecting a sudden data spike at high speed in the evaluation value estimating algorithm.

### CROSS-REFERENCE TO RELATED APPLICATION

This application is based upon and claims the benefit of priority of the prior Japanese Patent Application No. 2012-153589, filed on Jul. 9, 2012, the entire contents of which are incorporated herein by reference.

### FIELD

The embodiments discussed herein are directed to an evaluation apparatus, a distributed storage system, an evaluation method, and a computer readable recording medium having stored therein an evaluation program.

### BACKGROUND

For example, in a distributed storage system that handles big data, a phenomenon called a data spike is known.

In the data spike, when an access extremely concentrates on specific popular data and the data spike thus occurs, the access concentrates on only a server having popular data, and as a result, response performance of the server deteriorates.

The deterioration of the response performance of the server can be solved by finding the popular data and copying the popular data to the other servers having a small load, but before that copying, popularity of the data needs to be determined in the servers.

Herein, Let C be the number of access times to the data and N (=ΣiCi) be the total number of access times to a server having the data, then the popularity of the data P is denoted by P=C/N. However, to calculate the popularity P without an error, since the number of access times needs to be recorded for each data item, the consumed amount of memory increases in proportion to the number of data. As a result, when this method is adopted in a distributed storage system that handles an enormous number of data items such as the big data, the consumed amount of memory becomes enormous.

In order to solve the problem, some algorithms estimate the popularity within the range of ε where ε is a user-specified maximum error rate to reduce the required amount of memory. While these algorithms cannot strictly calculate the popularity, they do not need to record the access times of all data items. They only record the access times of a small number of data items enough to estimate the popularity within the user-specified error rate. It relaxes the memory pressure and enables to find the popular data items with less memory even on the distributed storage systems that handle the big data.

In particular, an algorithm called Space Saving has been known as a high speed, low memory, and high precision algorithm compared to the others. Hereinafter, the Space Saving algorithm will be schematically described.

FIG. 6 is a diagram illustrating a Stream-Summary data structure in the Space Saving algorithm, and FIG. 7 is a diagram illustrating a count update algorithm.

In the Space Saving algorithm, the Stream-Summary data structure illustrated in FIG. 6 is updated by the algorithm illustrated in FIG. 7 to estimate the popularity of data within ε.

The Stream-Summary data structure consists of not more than 1/ε elements that have a data name and an access count, and buckets that manage the elements. Each bucket manages the elements whose access counts are same in a list structure, and the buckets are managed by a list structure sorted in an ascending order of the access count of the managed elements.

When a data item denoted by D is accessed, the access count of the element whose data name is D is incremented. The estimated popularity of D is calculated by C/N, where C is the access count of the element whose data name is D and N (=ΣiCi) is a sum of the access counts of the all elements.

FIG. 8 is a flowchart describing the process of the Space Saving algorithm.

First, in step A1, it is verified whether a predetermined stop condition is provided, and when the stop condition is provided (see a route of YES in step A1), the process ends. When the stop condition is not provided (see a route of NO in step A1), it is verified whether access to the data is subsequently performed in step A2. Hereinafter, the accessing data item is denoted by D.

When the access to the data D is not performed (see a route of NO in step A2), the process returns to step A1.

When the access to the data D is provided (see a route of YES in step A2), it is verified whether the Stream-Summary has the element whose name is D, in step A3.

When the Stream-Summary has the element whose name is D (see a route of YES in step A3), the count of the element is incremented in step A5. Further, when the bucket that manages the data D will be changed by incrementing the count, the bucket that manages the data D is changed. In addition, the process returns to step A1.

When the Stream-Summary do not have the element whose name is D (see a route of NO in step A3), it is examined whether or not the number of elements of the Stream-Summary is full, in step A4. That is, it is verified whether the number of elements of the Stream-Summary is smaller than 1/ε. When the number of elements is smaller than 1/ε (see a route of YES in step A4), the number of elements does not reach a maximum number of elements of the Stream-Summary, and as a result, the element whose name is D and its count is one is added to the Stream-Summary, in step A6. Thereafter, the process returns to step A1.

When the number of elements is equal to or more than 1/ε (see a route of NO in step A4), the number of elements reaches the maximum, and thus it is full. In this case, in step A7, the leading element denoted by E of the list managed by the leading bucket is deleted, and instead, the element whose name is D and its count is equal to the access count of E (denoted by minCount in the figure) plus one is added to the Stream-Summary. As a result, the element having the minimum count is swapped for the element of D. Thereafter, the process returns to step A1.

As such, the Space Saving algorithm can calculate the popularity of data using at the maximum of 1/ε elements, and thus the consumption of the memory for the calculation does not depend on the number of data items.
[Non-Patent Literature 1] Ahmed Metwally, Divyakant Agrawal, Amr El Abbadi “An integrated efficient solution for computing frequent and top-k elements in data streams,” ACM Transactions on Database Systems (TODS), 2006.09, Volume 31, Issue3, pp. 1095-1133

However, the Space Saving and the other related algorithms cannot detect data spikes in real time.

In the Space Saving algorithm, for example, it keeps on counting the access from the start-up of the system and estimates the popularity during the overall running time. Therefore, if a sudden data spike occurs after a sufficient data access has been performed from the start-up of the system, the access counts during the data spike cannot make an impact on the popularity due to the past huge access counts.

### SUMMARY

As a result, an evaluation apparatus which estimates an evaluation value for an evaluation target content among a plurality of contents includes: a calculation unit configured to calculate the evaluation value of the evaluation target content by using an evaluation value estimation algorithm, based on a count value for the evaluation target content and a sum value of respective count values for the plurality of contents; a verification unit configured to verify whether the sum value of the respective count values for the plurality of contents reaches a predetermined value; and a processing unit configured to reduce the respective count values of the plurality of contents, when the sum value of the respective count values for the plurality of contents reaches the predetermined value.

Further, a distributed storage system includes: a plurality of node devices configured to distribute and store a plurality of contents; a calculation unit configured to calculate an evaluation value of an evaluation target content by using an evaluation value estimation algorithm, based on the number of accesses to the evaluation target content among the plurality of contents and a sum value of the respective numbers of accesses to the plurality of contents; a verification unit configured to verify whether the sum value of the respective numbers of accesses to the plurality of contents reaches a predetermined value; and a processing unit configured to reduce the respective numbers of accesses to the plurality of contents, when the sum value of the respective numbers of accesses to the plurality of contents reaches the predetermined value.

Further, an evaluation method which estimates an evaluation value for an evaluation target content among a plurality of contents includes: by a computer, verifying whether a sum value of respective count values for the plurality of contents reaches a predetermined value; reducing the respective count values of the plurality of contents, when the sum value of the respective count values for the plurality of contents reaches the predetermined value; and calculating the evaluation value of the evaluation target content by using an evaluation value estimation algorithm, based on a count value for the evaluation target content and a sum value of the respective count values for the plurality of contents.

Further, in a computer readable recording medium having stored therein an evaluation program to estimate an evaluation value for an evaluation target content among a plurality of contents, the evaluation program causes a computer to verify whether a sum value of respective count values for the plurality of contents reaches a predetermined value; reduce the respective count values of the plurality of contents, when the sum value of the respective count values for the plurality of contents reaches the predetermined value; and calculate the evaluation value of the evaluation target content by using an evaluation value estimation algorithm, based on a count value for the evaluation target content and a sum value of the respective count values for the plurality of contents.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a functional configuration of a distributed storage system including a management server as an embodiment;

FIG. 2 is a diagram schematically illustrating a configuration of the distributed storage system including the management server as the embodiment;

FIG. 3 is a flowchart describing an updating method of a count value in the distributed storage system as the embodiment;

FIG. 4 is a flowchart describing processing when a shrink processing unit reduces a count value in the distributed storage system as the embodiment;

FIG. 5 is a diagram illustrating an algorithm of count shrink processing in the distributed storage system as the embodiment;

FIG. 6 is a diagram illustrating a Stream-Summary data structure in a Space Saving algorithm;

FIG. 7 is a diagram illustrating a count updating algorithm in the Space Saving algorithm; and

FIG. 8 is a flowchart describing the process of the Space Saving algorithm.

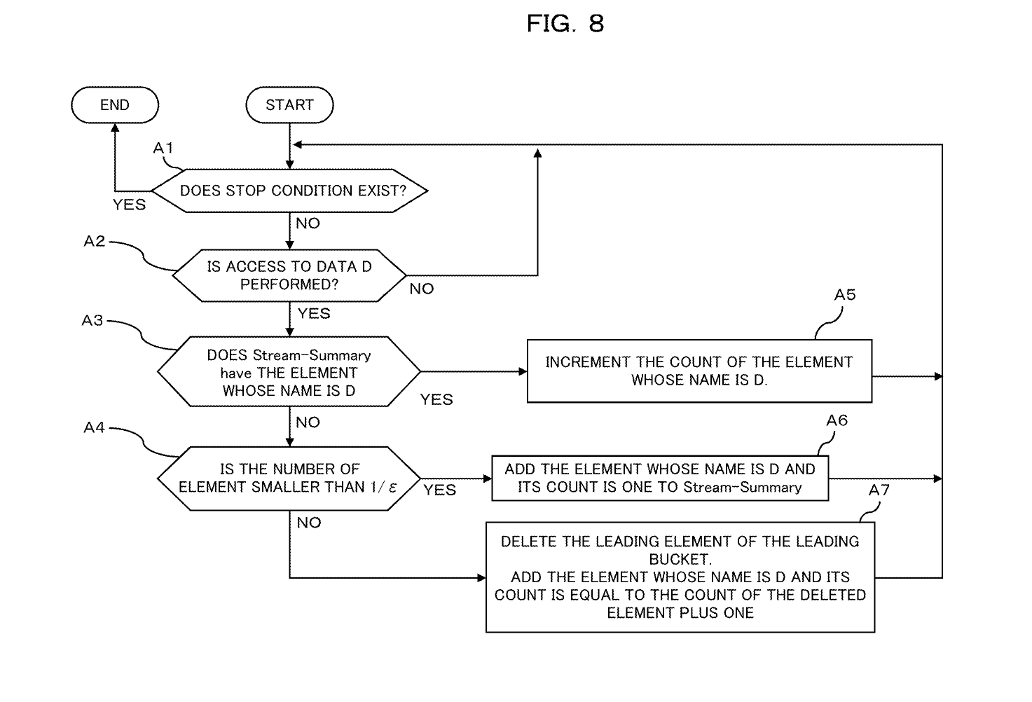

### DESCRIPTION OF EMBODIMENTS

Hereinafter, embodiments according to an evaluation apparatus, a distributed storage system, an evaluation method, and an evaluation program will be described with reference to the drawings. However, the embodiments described below are just examples, and various modified examples or applications of a technology which are not described in the embodiments described below do not intend to be excluded. That is, the embodiments can be variously modified within the scope without departing from the spirit. Further, each drawing may include not only components illustrated in the drawing but also other functions, and the like.

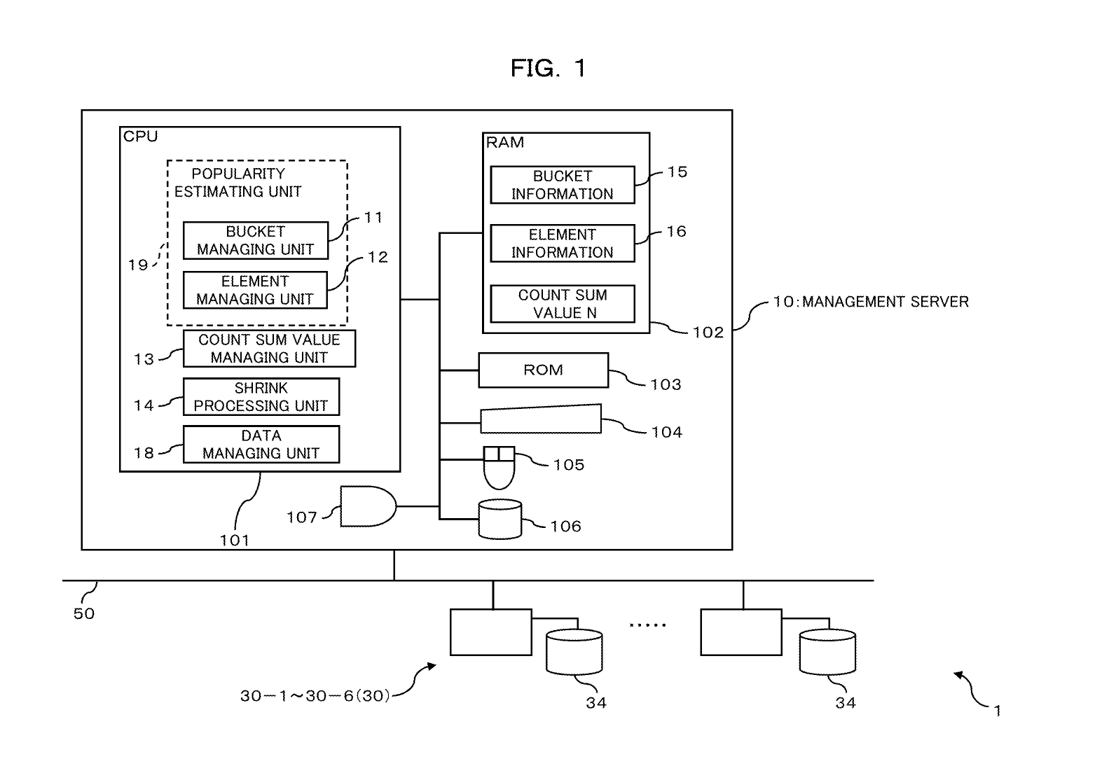

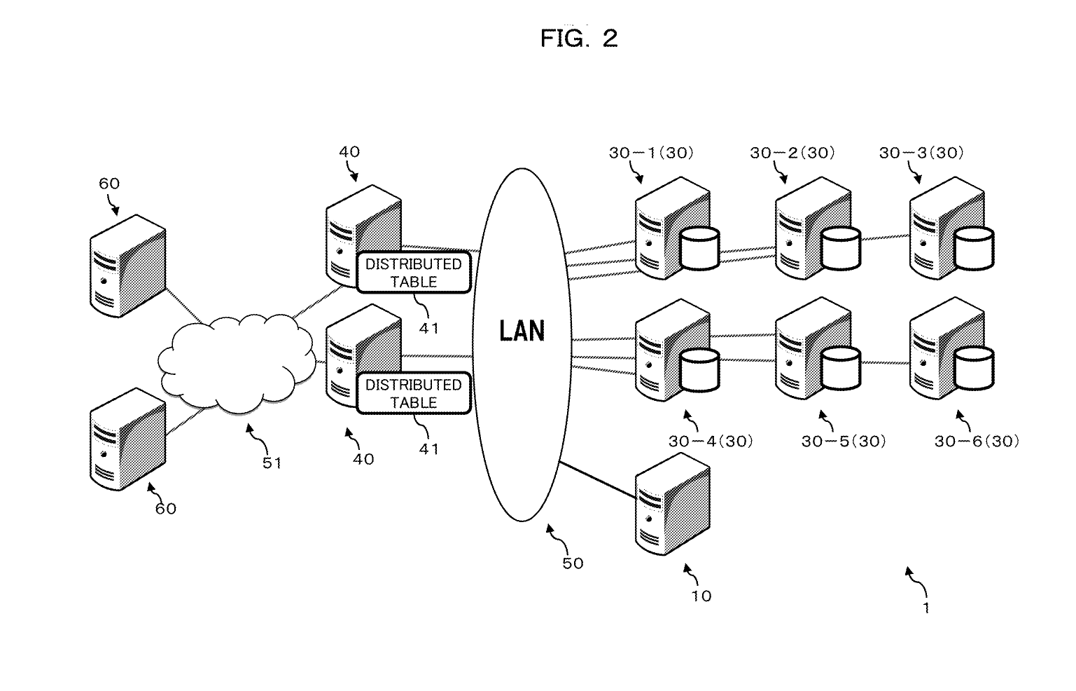

FIG. 1 is a diagram schematically illustrating a functional configuration of a distributed storage system including a management server (evaluation apparatus) as an embodiment, and FIG. 2 is a diagram schematically illustrating a configuration of the distributed storage system including the management server.

A distributed storage system 1 includes a management server 10, a proxy server 40, a client 60, and storage server nodes (storage devices) 30-1 to 30-6, as illustrated in FIG. 2. However, in FIG. 1, the client 60 and the proxy server 40 are not illustrated for convenience.

In an embodiment illustrated in FIG. 2, the management server 10 and the respective storage server nodes from 30-1 to 30-6, and each proxy server 40 are connected to communicate with each other through, for example, a local area network (LAN) 50. Further, each proxy server 40 and each client 60 are connected to communicate with each other through a network 51 such as a public line network, or the like.

The distributed storage system 1 arranges disk areas of a plurality of respective storage server nodes 30-1 to 30-6 to handle the disk areas like one storage. In the distributed storage system 1, a plurality of data files (data and contents) are distributed and arranged in the plurality of storage server nodes from 30-1 to 30-6.

Hereinafter, as reference numerals which denote the storage server nodes, reference numerals from 30-1 to 30-6 are used when one server node of the plurality of storage server nodes needs to be specified, but reference numeral 30 is used at the time of indicating any storage server node.

The storage server node 30 is a computer having a server function and includes a storage device 34.

The storage device 34 is a storage device storing various data or programs, for example, a hard disk drive (HDD) or a solid state drive (SSD). Further, as the storage device 34, for example, redundant arrays of inexpensive disks (RAID) may be constituted by a plurality of storage devices, and various modifications of the storage device may be made.

The storage device 34 stores a data file read or written from each client 60.

In addition, in the distributed storage system 1, data (contents, and evaluation target contents) are distributed and stored in the storage device 34 of the plurality of storage server nodes 30.

In the embodiment illustrated in FIG. 2, six storage server nodes 30 are provided in the distributed storage system 1, but the invention is not limited thereto and five or less or seven or more storage server nodes 30 may be provided.

The client 60 is, for example, an information processing device such as a personal computer or the like, and the client 60 performs a request for reading or writing (reading/writing request) the data (contents) stored in the storage server node 30 through the proxy server 40. In the embodiments illustrated in FIGS. 1 and 2, two clients 60 are provided in the distributed storage system 1, but the invention is not limited thereto and one or three or more clients 60 may be provided.

The client 60 transmits the reading/writing requests to the proxy server 40 together with information specifying data such as a file name (object name) to be accessed, or the like. Herein, contents accessed from the client 60 may be just referred to as data.

The proxy server 40 performs data access to the storage server node 30 instead of the client 60. Each proxy server 40 is an information processing apparatus such as a computer having the server function and the respective proxy servers 40 include the same configuration as each other. In the embodiments illustrated in FIGS. 1 and 2, two proxy servers 40 are provided in the distributed storage system 1, but the invention is not limited thereto and one or three or more proxy servers 40 may be provided.

Each proxy server 40 includes a distributed table 41. The distributed table 41 is configured by associating information specifying the data file with a storage position of the data file. The proxy server 40 verifies a storage place of the data file to be accessed by referring to the distributed table 41 based on a received file name when receiving a reading/writing request of the data file from the client 60. The proxy server 40 transmits the reading/writing requests to the storage server node 30 corresponding to the storage place of the data file. Further, when the proxy server 40 receives a reply to the reading/writing requests from the storage server node 30, the proxy server 40 transmits the reply to the client 60 of a transmission source of the reading/writing requests.

Note that, a function as the proxy server 40 is implemented by various known methods, and a detailed description thereof will not be made.

The management server 10 is an information processing apparatus such as a computer having the server function and performs various settings or controls in the distributed storage system 1.

The management server 10 includes a central processing unit (CPU) 101, a random access memory (RAM) 102, a read only memory (ROM) 103, a keyboard 104, a pointing device 105, a storage device 106, and a display 107, as illustrated in FIG. 1.

The storage device 106 as a storage device storing an operating system (OS) or a program executed by the CPU 101, various data, and the like, is an HDD or an SSD, for example. Further, as the storage device 106, for example, an RAID may be constituted by the plurality of storage devices and various modifications of the storage device may be implemented.

The ROM 103 is a storage device storing the program executed by the CPU 101, various data, or the like. The RAM 102 as a storage area storing various data or programs is used by storing and developing the data or programs when the CPU 101 executes the program. Further, the RAM 102 stores bucket information 15, element information 16, and a count sum value N.

The bucket information 15 is information on a bucket used when a bucket managing unit 11 of a popularity estimating unit (calculating unit) 19 to be described below estimates popularity by using a Space Saving algorithm. In a Stream-Summary data structure, data (element) having the same count is associated with the same bucket. The bucket information 15 includes information specifying a count of data associated with each bucket or information specifying data (element) associated to the bucket. Note that, a value of the count (count value) represents the number of accesses performed with respect to the data (contents).

Note that, in the Space Saving algorithm, the count value is strictly an approximate value to the number of accesses, but simply referred to as the number of accesses for convenience.

The element information 16 is information on an element used when an element managing unit 12 of the popularity estimating unit 19 to be described below estimates the popularity by using the Space Saving algorithm and information on elements of the Stream-Summary data structure. The element information 16 includes information (for example, a storage location address or data name) to identify data registered as the element and a count value indicating the number of access to the data.

The count sum value N is a sum of count values of respective data registered in the element information 16.

The keyboard 104 and the pointing device 105 are input devices where a user performs various input operations. The pointing device 105 is, for example, a touch pad or a mouse. The display 107 is an output device displaying various information or messages.

Note that, functions as the keyboard 104 or the pointing device 105 and the display 107 may be implemented by a touch panel display having the functions and may be variously modified.

The CPU 101 which is a processing apparatus that performs various controls or calculations implements various functions by executing an OS or programs stored in the ROM 103, or the like. In detail, the CPU 101 serves as a popularity estimating unit 19, a count sum value managing unit 13, a shrink processing unit 14, and a data managing unit 18, as illustrated in FIG. 1.

Note that, programs (evaluation programs) for implementing functions as the popularity estimating unit 19, the count sum value managing unit 13, the shrink processing unit 14, and the data managing unit 18 are provided to be recorded in computer readable recording media including, for example, a flexible disk, a CD (a CD-ROM, a CD-R, a CD-RW, or the like), a DVD (a DVD-ROM, a DVD-RAM, a DVD-R, a DVD+R, a DVD-RW, a DVD+RW, an HD, a DVD, or the like), a Blue-ray disk, a magnetic disk, an optical disk, a magneto-optical disk, and the like. In addition, the computer reads the programs from the recording media and transmits and stores the programs to an internal storage device or an external storage device to use the programs. Further, the programs may be recorded in the storage devices (recording media) including, for example, the magnetic disk, the optical disk, the magneto-optic disk, and the like and provided to the computer from the storage devices through a communication channel.

When the functions as the popularity estimating unit 19, the count sum value managing unit 13, the shrink processing unit 14, and the data managing unit 18 are implemented, the programs stored in the internal storage device (the RAM 102 or the ROM 103 in the embodiment) are executed by a microprocessor (the CPU 101 in the embodiment) of the computer. In this case, the computer may read and execute the programs recorded in the recording media.

Note that, in the embodiment, the computer is a concept including hardware and an operating system and means hardware which operates under the control of the operating system. Further, when the operating system is not required and an application program operates the hardware for itself, the hardware itself corresponds to the computer. The hardware at least includes the microprocessor such as the CPU, or the like and a unit for reading the computer programs recorded in the recording media and in the embodiment, the management server 10 serves as the computer.

The data managing unit 18 manages data stored by each storage server node 30 in the distributed storage system 1.

The data managing unit 18 distributes and rearranges (moves) data having high popularity in the plurality of storage server nodes 30 so as to prevent a load from concentrating on some storage server nodes 30 among the plurality of storage server nodes 30 provided in the distributed storage system 1.

The data managing unit 18 specifies the data having high popularity based on the popularity (evaluation value) calculated by the popularity estimating unit 19.

Further, when the data managing unit 18 rearranges the data among the storage server nodes 30, the data managing unit 18 notifies a result of the data rearrangement to the proxy server 40 and updates the distributed table 41.

The popularity estimating unit (calculating unit) 19 calculates the popularity (evaluation value) of each data (evaluation target contents) of each storage server node 30 in the distributed storage system 1.

When the client 60 accesses the contents of the storage server node 30, the storage server node 30 or the proxy server 40 at least notifies information to identify the accessed data to the management server 10.

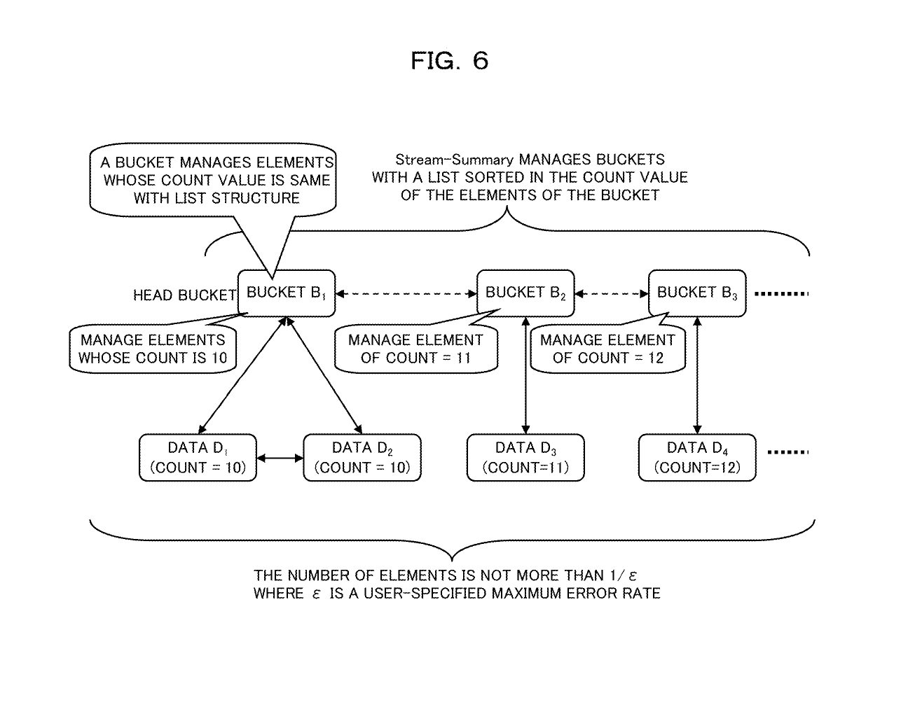

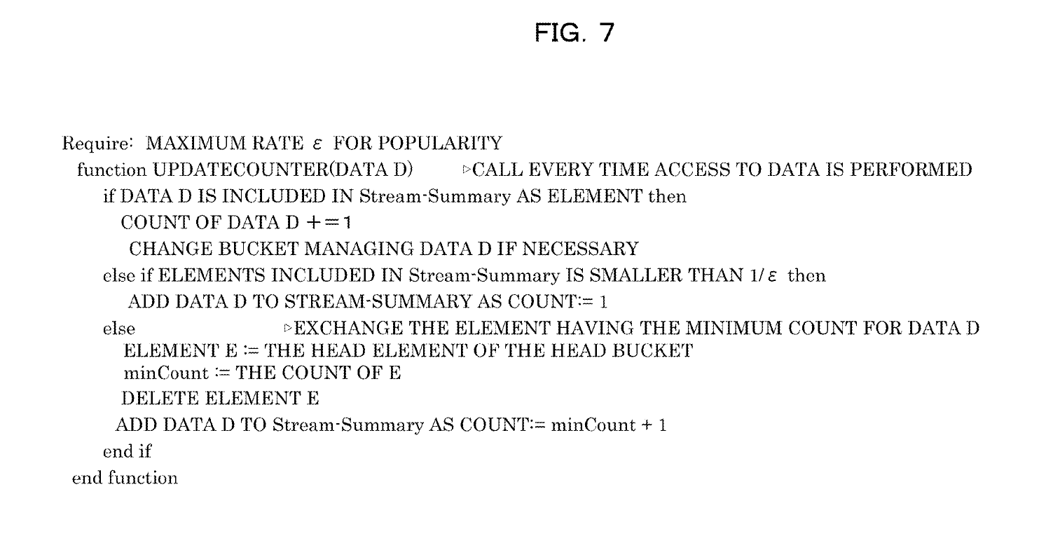

The popularity estimating unit 19 has functions as the bucket managing unit 11 and the element managing unit 12, and estimates popularity for each data by using the Space Saving algorithm (evaluation value estimating algorithm). That is, the popularity estimating unit 19 manages the Stream-Summary data structure illustrated in FIG. 6. In addition, the popularity estimating unit 19 estimates the popularity for the data at a maximum error rate 8 by executing a count update algorithm illustrated in FIG. 7 whenever the access is performed to each data of each storage server node 30 in the distributed storage system 1.

The bucket managing unit 11 manages the bucket in the Stream-Summary data structure by using the bucket information 15 of the RAM 102. In the Stream-Summary data structure, the data (content) D is managed as an element E and further, the number of accesses to each data is managed as a count value, as illustrated in FIG. 6.

The bucket managing unit 11 creates or deletes the bucket information 15 and further, manages the same element having the same count value. The bucket managing unit 11 manages the buckets in a list (not illustrated) sorted with count values of elements of the respective buckets.

Further, in the distributed storage system 1, when the shrink processing unit 14 to be described below changes (reduces) the count value of the data, the bucket managing unit 11 associates the element with the bucket again in accordance with the changed count value.

The shrink processing unit 14 changes the count value of the data as described below, and as a result, adjacent buckets in the Stream-Summary data structure may have data having the same count as each other. In this case, the bucket managing unit 11 associates the element with the bucket in accordance with the changed count value of each data again, and as a result, data of different buckets before the change may be associated with the same bucket. Herein, associating of the data having different buckets before the change with the same bucket by performing the association with the bucket in accordance with the changed count value of each data again may be referred to as merging of the bucket.

In addition, the popularity estimating unit 19 acquires popularity P of evaluation target data (evaluation target contents) by calculating popularity P=

C/N where C is a count value of the data and N is a count sum value managed by the count sum value managing unit 13 to be described below.

The element managing unit 12 manages the element in the Stream-Summary data structure by using the element information 16 of the RAM 102. The element managing unit 12 manages not more than 1/ε elements where ε is the maximum error rate. These elements are registered in the element information 16.

The element managing unit 12 creates or deletes the element information 16, and updates a count value for data registered as the element.

That is, whenever access to the data is performed, the element managing unit 12 updates a count value of the data. Note that, the access to the data may be acquired from the proxy server 40 and further, notified from each storage server node 30.

Further, in the distributed storage system 1, when the shrink processing unit 14 to be described below changes the count value of each data, the bucket managing unit 11 updates the count value of each data in the element information 16 to the changed value.

The count sum value managing unit 13 manages the sum of the count values of the respective data by using the count sum value N of the RAM 102. The count sum value managing unit 13 sums up the respective count values of all 1/ε data managed by the element managing unit 12 and stores the sum-up count value in the RAM 102 as the count sum value N.

Further, in the distributed storage system 1, when the shrink processing unit 14 to be described below changes the count value of each data, the bucket managing unit 11 uses and sums up the changed count values again and updates the count sum value N.

The shrink processing unit (processing unit) 14 compares the count sum value N with a predetermined threshold value Nt, and when the count sum value N is larger than the threshold value Nt, the shrink processing unit 14 uniformly shrinks the count values of all of the data registered in the element information 16. In detail, the shrink processing unit 14 reduces (shrinks) the count value of each data at (1−α) times to update the count value, where 0<α<1. For example, α=0.875 or ⅞.

That is, the shrink processing unit 14 performs importance evaluation depending on a time axis so that the popularity becomes an exponential moving average having a as a planarization coefficient.

Further, the shrink processing unit 14 rounds up to numbers as the result of shrinking the count value of each data at (1−α) times. Hereinafter, the reducing of the count value of each data at (1−α) times may be called count shrinking.

As a result, the count sum value N of the RAM 102 is also reduced as described above. The count sum value N after the reduction is a value including both the value of (1−α) times before the reduction and a round-up error when reducing the count value of the data at (1−α) times.

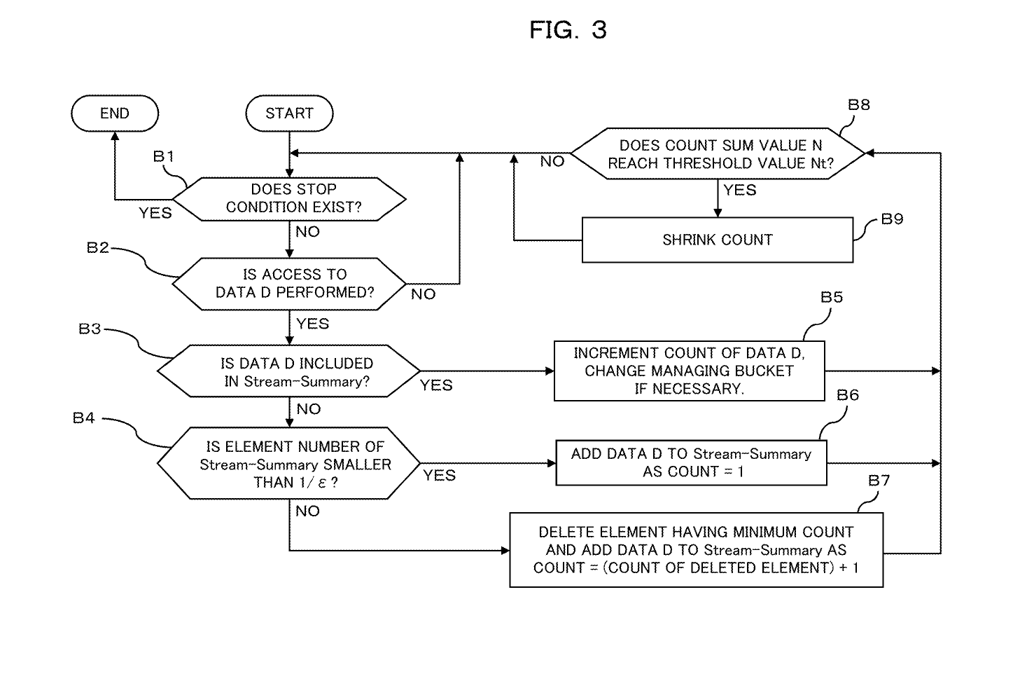

The updating method of the count value in the distributed storage system 1 as an example of the embodiment, which is configured as described above will be described with reference to a flowchart (steps from B1 to B9) illustrated in FIG. 3.

First, in step B1, it is verified whether a predetermined stop condition is provided, and when the stop condition is provided (see a route of YES in step B1), the process ends. When the stop condition is not provided (see a route of NO in step B1), it is verified whether access to the data D is subsequently performed in step B2.

When the access to the data D is not performed (see a route of NO in step B2), the process returns to step B1.

When the access to the data D is performed (see a route of YES in step B2), it is verified whether the data D is included in the Stream-Summary as an element, in step B3.

When the data D is included in the Stream-Summary as the element (see a route of YES in step B3), the count of the element is incremented in step B5. Further, when the bucket that manages the data D is changed by incrementing the count, the bucket that manages the data D is changed.

In addition, in step B8, the shrink processing unit 14 verifies whether the count sum value N reaches the threshold value Nt. When the count sum value N does not reach the threshold value Nt (see a route of NO in step B8), the process returns to step B1.

When the count sum value N reaches the threshold value Nt (see a route of YES in step B8), the shrink processing unit 14 reduces each count value (count shrinking) by reducing the count values of all of the data registered in the element information 16 at (1−α) times, in step B9. Thereafter, the process returns to step B1.

Further, when the data D is not included in the Stream-Summary (see a route of NO in step B3), it is examined whether or not the number of elements of the Stream-Summary is full, in step B4. That is, it is verified whether the number of elements of the Stream-Summary is smaller than 1/ε. When the number of elements is smaller than 1/ε (see a route of YES in step B4), the number of elements does not reach a maximum element number of the Stream-Summary. Therefore, in step B6, the data D is added to the Stream-Summary as count=1. Thereafter, the process proceeds to step B8.

When the number of elements is equal to or more than 1/ε (see a route of NO in step B4), the number of elements reaches the maximum element number and thus, the number of elements is full. In this case, in step B7, a leading element (a count is represented by minCount) of a list managed by a leading bucket is deleted, while the data D is added to the Stream-Summary as a count (=minCount+1). As a result, an element having the minimum count and the data D are exchanged with each other. Thereafter, the process proceeds to step B8.

An approximate value of the count value of each data (the number of accesses) may be acquired by referring to the updated Stream-Summary data structure. In particular, the number of accesses (count value) to data to which the access is frequently performed may be acquired, and the popularity estimating unit 19 calculates the popularity P by using the count value and the count sum value N.

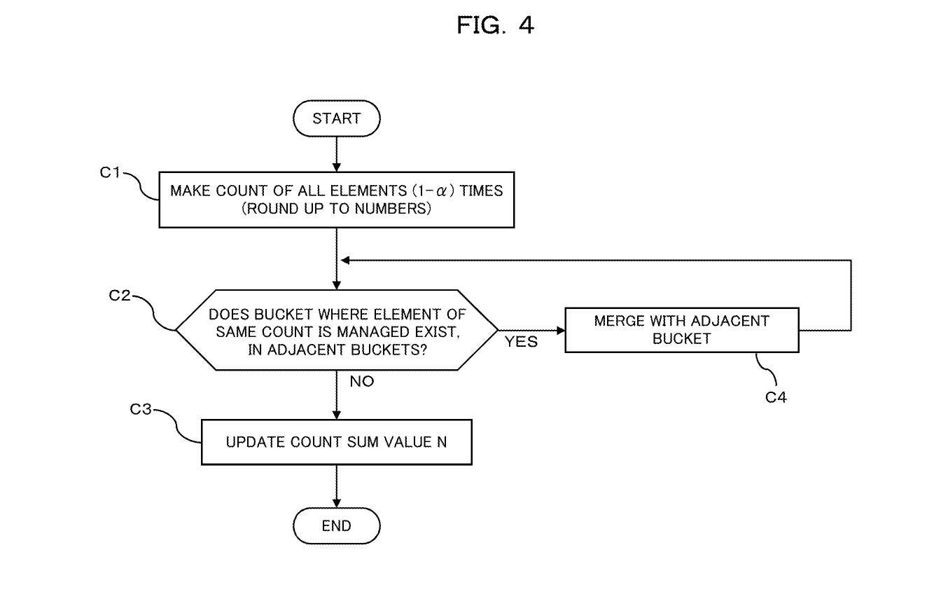

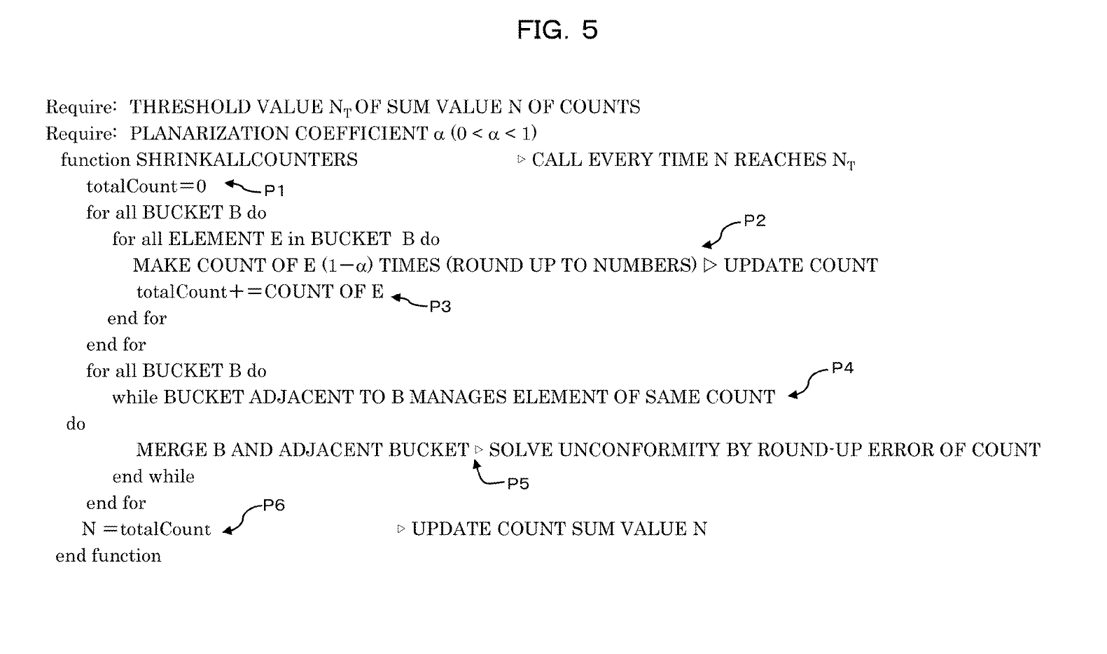

Subsequently, the count shrink processing by the shrink processing unit 14 in the distributed storage system 1 as an example of the embodiment will be described with reference to a flowchart (steps from C1 to C4) illustrated in FIG. 4 with reference to FIG. 5. FIG. 5 is a diagram illustrating an algorithm of the count shrink processing. Note that, in an embodiment illustrated in FIG. 5, the count shrink processing is illustrated in a format of a program.

The count shrink processing is executed when it is detected that the count sum value N reaches the threshold value Nt in step B8 of the flowchart of FIG. 3. In the embodiment illustrated in FIG. 5, the count shrink processing is represented as a function name called “SHRINK ALL COUNTERS”. Note that, in the embodiment illustrated in FIG. 5, a variable, “totalCount” is used to calculate the count sum value N.

First, in step C1, the count sum value N is reset to 0 (see an arrow P1 of FIG. 5), and thereafter, the shrink processing unit 14 reduces count values for respective elements E registered in the element information 16 at (1−α) times (see an arrow P2 of FIG. 5). Processing of reducing the count value of the element E at (1−α) times is performed with respect to all of the elements E registered in the element information 16.

Further, the count value of the element E reduced at (1−α) times is added to the count sum value N, and a value of “totalCount” is sequentially updated (see an arrow P3 of FIG. 5). Further, in FIG. 5, the reduction at (1−α) times and the update of the count sum value are sequentially performed with respect to all of the elements included in the bucket, and further, the processing is performed with respect to all of the buckets.

Thereafter, in step C2, the bucket managing unit 11 verifies whether the bucket of managing the elements having the same count is generated by reducing the count value in step C1 (see an arrow P4 of FIG. 5).

When a plurality of buckets managing the elements having the same count are provided (see a route of YES in step C2), buckets managing the elements having the same count are merged with each other in step C4 (see an arrow P5 of FIG. 5). Thereafter, the process returns to step C2.

When no bucket managing the elements having the same count is provided (see a route of NO in step C2), the count sum value N is updated by using the value of “totalCount” in step C3 (see an arrow P6 of FIG. 5). Thereafter, the process ends.

As such, according to the distributed storage system 1 as an example of the embodiment, when the count sum value N reaches Nt, the count values of all of the elements are reduced at (1−α) times. With this, the count sum value N is also reduced to a value close to (1−α)N.

As a result, since the count sum value N which is a divisor for calculating the popularity P (=C/N) of each data is reduced, the variation of the count value C of each data is easily reflected on the popularity P and the data spike may be easily detected. That is, the variation of the popularity caused by the data spike may be increased by reducing an influence of the access on the popularity in the past. That is, the importance evaluation of the popularity depending on the time axis may be implemented so as to emphasize recent popularity.

Further, a technique of a disclosure is not limited to the foregoing embodiment and various modifications may be made within the scope without departing from the spirit of the embodiment. Each configuration and each processing of the embodiment may be selected as necessary or may be appropriately combined.

For example, in the embodiments, the management server 10 has the function as the popularity estimating unit 19, the count sum value managing unit 13, the shrink processing unit 14, and the data managing unit 18, but the invention is not limited thereto. At least some of the functions as the popularity estimating unit 19, the count sum value managing unit 13, the shrink processing unit 14, and the data managing unit 18 may be provided in the storage server node 30.

That is, the storage server node 30 has a function as the evaluation apparatus, and the popularity of the data (contents) stored in the storage device 34 is calculated, and the data having high popularity may be distributed and rearranged (moved) in other storage server nodes 30.

Further, in the embodiments, the popularity estimating unit 19 estimates the popularity for each data by using the Space Saving algorithm as an evaluation value estimating algorithm, but the invention is not limited thereto. That is, the popularity may be estimated by using an evaluation value estimating algorithm other than the Space Saving algorithm, and the shrink processing unit 14 may decrease a count value of data used in the evaluation value estimating algorithm.

According to the embodiment, a sudden data spike may be detected at high speed in the evaluation value estimating algorithm.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An evaluation apparatus which estimates an evaluation value for an evaluation target content among a plurality of contents, the apparatus comprising:
a calculation unit configured to calculate the evaluation value of the evaluation target content by using an evaluation value estimation algorithm, based on a count value for the evaluation target content and a sum value of respective count values for the plurality of contents;
a verification unit configured to verify whether the sum value of the respective count values for the plurality of contents reaches a predetermined value; and
a processing unit configured to reduce the respective count values of the plurality of contents, when the sum value of the respective count values for the plurality of contents reaches the predetermined value.

2. The evaluation apparatus according to claim 1, wherein the processing unit reduces the respective count values for the plurality of contents by (1−α) times (0<α<1).

3. The evaluation apparatus according to claim 1, wherein the processing unit converts the reduced count values into integer values by rounding up to the reduced count values for the plurality of contents.

4. The evaluation apparatus according to claim 1,
wherein the evaluation value estimation algorithm is a Space Saving algorithm, and
association of buckets in a Stream-Summary data structure of the Space Saving algorithm is performed, in accordance with the reduced respective count values for the plurality of contents.

5. A distributed storage system, comprising:
a plurality of node devices configured to distribute and store a plurality of contents;
a calculation unit configured to calculate an evaluation value of an evaluation target content by using an evaluation value estimation algorithm, based on the number of accesses to the evaluation target content among the plurality of contents and a sum value of the respective numbers of accesses to the plurality of contents;
a verification unit configured to verify whether the sum value of the respective numbers of accesses to the plurality of contents reaches a predetermined value; and
a processing unit configured to reduce the respective numbers of accesses to the plurality of contents, when the sum value of the respective numbers of accesses to the plurality of contents reaches the predetermined value.

6. The distributed storage system according to claim 5, wherein the processing unit reduces the respective numbers of accesses to the plurality of contents by (1−α) times (0<α<1).

7. The distributed storage system according to claim 5, wherein the processing unit converts the reduced respective numbers of accesses into integer values by rounding up to the reduced respective numbers of accesses to the plurality of contents.

8. The distributed storage system according to claim 5,
wherein the evaluation value estimation algorithm is a Space Saving algorithm, and
association of buckets in a Stream-Summary data structure of the Space Saving algorithm is performed in accordance with the respective numbers of accesses to the plurality of contents.

9. An evaluation method which estimates an evaluation value for an evaluation target content among a plurality of contents, the method comprising:
by a computer,
verifying whether a sum value of respective count values for the plurality of contents reaches a predetermined value;
reducing the respective count values of the plurality of contents, when the sum value of the respective count values for the plurality of contents reaches the predetermined value; and
calculating the evaluation value of the evaluation target content by using an evaluation value estimation algorithm, based on a count value for the evaluation target content and a sum value of the respective count values for the plurality of contents.

10. The evaluation method according to claim 9, wherein the respective count values for the plurality of contents are reduced by (1−α) times (0<α<1).

11. The evaluation method according to claim 9, wherein the processing unit converts the reduced respective count values into integer values by rounding up to the reduced respective count values for the plurality of contents.

12. The evaluation method according to claim 9,
wherein the evaluation value estimation algorithm is a Space Saving algorithm, and
association of buckets in a Stream-Summary data structure of the Space Saving algorithm is performed in accordance with the reduced respective count values for the plurality of contents.

13. A computer readable recording medium which records an evaluation program to estimate an evaluation value for an evaluation target content among a plurality of contents,
wherein the evaluation program, in a computer,
verifies whether a sum value of respective count values for the plurality of contents reaches a predetermined value;
reduces the respective count values of the plurality of contents, when the sum value of the respective count values for the plurality of contents reaches the predetermined value; and
calculates the evaluation value of the evaluation target content by using an evaluation value estimation algorithm, based on a count value for the evaluation target content and a sum value of the respective count values for the plurality of contents.

14. The computer readable recording medium according to claim 13, wherein the respective count values for the plurality of contents are reduced (1−α) times (0<α<1).

15. The computer readable recording medium according to claim 13, wherein the reduced respective count values are converted into integer values by rounding up to the reduced respective count values for the plurality of contents.

16. The computer readable recording medium according to claim 13,
wherein the evaluation value estimation algorithm is a Space Saving algorithm, and
association of buckets in a Stream-Summary data structure of the Space Saving algorithm is performed in accordance with the reduced respective count values for the plurality of contents.
